(19) United States
(12) Patent Application Publication
(10) Pub. No.: US 2021/0331528 A1
(43) Pub. Date: Oct. 28, 2021

(54) THREE-DIMENSIONAL TIRE SIPE

(71) Applicant: Bridgestone Americas Tire Operations, LLC, Nashville, TN (US)

(72) Inventors: Reubin R. Close, Rootstown, OH (US); Andrew T. Miklic, Akron, OH (US); Andrew C. Budd, Clinton, OH (US); Brandon P. Nelson, Stow, OH (US); Lee A. Fish, Newcomerstown, OH (US); Charles D. Berry, Akron, OH (US)

(21) Appl. No.: 16/479,829

(22) PCT Filed: Jan. 29, 2018
(86) PCT No.: PCT/US2018/015675

§ 371 Date: Jul. 22, 2019

Related U.S. Application Data
(60) Provisional application No. 62/451,738, filed on Jan. 29, 2017.

(51) Int. Cl. B60C 11/12

(52) U.S. Cl. CPC B60C 11/1218; B60C 2011/1213; B60C 11/1281

(57) ABSTRACT

Various embodiments of a tire having a three-dimensional tire sipe are disclosed. In one embodiment, a tire having a sipe is provided, the tire comprising: opposing tread element portions separated by the sipe, each opposing tread element portion including a plurality of positive elements and a plurality of negative elements, wherein the plurality of positive elements and the plurality of negative elements include three substantially quadrilateral-shaped planar surfaces, each planar surface being oriented relative to another planar surface by an angle of 90 degrees, and wherein the three planar surfaces meet at a rounded terminal portion.

### BACKGROUND

Tires for use on vehicles may comprise a tread featuring sipes. The presence of sipes in a tire tread may create more surface edges to engage a roadway, which may increase traction in adverse road conditions. For example, a tire tread including sipes may perform better in icy, snowy, or wet road conditions than a tire tread not including sipes. Likewise, the more sipes a tire has, the better traction it may exhibit in adverse road conditions.

However, the addition of sipes to a tire tread block may reduce block stiffness, which may result in undesirable irregular wear patterns in the tire and a decrease in tire performance in dry road conditions (i.e., non-adverse conditions). Increasing the number of sipes in a tire tread block may relate to a decrease in stiffness of that tire tread block.

What is needed is a tire sipe configured to provide adequate traction in adverse road conditions, while maintaining the required stiffness for dry road conditions, and while resisting irregular wear patterns.

### SUMMARY

In one embodiment, a tire having a sipe is provided, the tire comprising: opposing tread element portions separated by the sipe, each opposing tread element portion including a plurality of positive elements and a plurality of negative elements, wherein the plurality of positive elements and the plurality of negative elements include three substantially quadrilateral-shaped planar surfaces, each planar surface being oriented relative to another planar surface by an angle of 90 degrees, and wherein the three planar surfaces meet at a rounded terminal portion.

In one embodiment, a tire having a sipe is provided, the tire comprising: opposing tread element portions separated by the sipe, each opposing tread element portion including a plurality of positive elements and a plurality of negative elements, wherein the plurality of positive elements and the plurality of negative elements include six planar side surfaces having a trapezoidal shape, each planar side surface being oriented relative to an adjacent planar side surface by an angle of 120 degrees, and wherein the six planar side surfaces are each connected to a planar terminal surface having a hexagonal shape, wherein the planar terminal portion is parallel to a sipe centerline.

In one embodiment, a sipe blade for forming a sipe in a tire is provided, the sipe blade comprising: a central plane, and a plurality of positive elements and a plurality of negative elements, wherein the plurality of positive elements and the plurality of negative elements include three substantially quadrilateral-shaped planar surfaces, each planar surface being oriented relative to another planar surface by an angle of 90 degrees, and wherein the three planar surfaces meet at a rounded terminal portion.

In one embodiment, a sipe blade for forming a sipe in a tire is provided, the sipe blade comprising: a central plane, and a plurality of positive elements and a plurality of negative elements, wherein the plurality of positive elements and the plurality of negative elements include six planar side surfaces having a trapezoidal shape, each planar side surface being oriented relative to an adjacent planar side surface by an angle of 120 degrees, and wherein the six planar side surfaces are each connected to a planar terminal surface having a hexagonal shape, wherein the planar terminal portion is parallel to the central plane.

### BRIEF DESCRIPTION OF THE DRAWINGS

The accompanying figures, which are incorporated in and constitute a part of the specification, illustrate various example configurations, and are used merely to illustrate various example embodiments. In the figures, like elements bear like reference numerals.

FIG. 1A illustrates a perspective view of an example sipe blade 100 for forming a three-dimensional tire sipe.

FIG. 1B illustrates an elevation view of an example sipe blade 100 for forming a three-dimensional tire sipe.

FIG. 1C illustrates an elevation view of an example sipe blade 100 for forming a three-dimensional tire sipe.

FIG. 2A illustrates a sectional view of an example sipe blade 200 for forming a three-dimensional tire sipe.

FIG. 2B illustrates a sectional view of an example sipe blade 200 for forming a three-dimensional tire sipe.

FIG. 3 illustrates a perspective view of an example sipe blade 300 for forming a three-dimensional tire sipe.

FIG. 4 illustrates a perspective view of a tire section 430 illustrating molding using a sipe blade 400 for forming a three-dimensional tire sipe.

FIG. 5 illustrates a plan view of a tire tread element 534 illustrating engagement between a first and second element of a three-dimensional tire sipe.

FIG. 6 illustrates a perspective view of an example sipe blade 600 for forming a three-dimensional tire sipe.

FIG. 7 illustrates a sectional view of an example sipe blade 740 for forming a three-dimensional tire sipe.

FIG. 8A illustrates an elevation view of a three-dimensional element for forming a three-dimensional tire sipe.

FIG. 8B illustrates a plan view of a three-dimensional element for forming a three-dimensional tire sipe.

FIG. 9 illustrates an elevation view of an example sipe blade 900 for forming a three-dimensional tire sipe.

FIG. 10 illustrates a plan view of a tire tread element 1060 illustrating engagement between a first and second element of a three-dimensional tire sipe.

FIG. 11 illustrates a perspective view of an example sipe blade 1100 for forming a three-dimensional tire sipe.

FIG. 12 illustrates a sectional view of an example sipe blade 1200 for forming a three-dimensional tire sipe.

FIG. 13A illustrates a perspective view of an example sipe blade 1300 arranged in a mold 1390 for forming a three-dimensional tire sipe.

FIG. 13B illustrates a detail view of example sipe blade 1300 arranged in a mold 1390 for forming a three-dimensional tire sipe.

### DETAILED DESCRIPTION

Tires not intended for operation on smooth, dry surfaces typically comprise a tread pattern, including a least one groove, at least one rib, and/or a plurality of tread blocks. Tires intended for operation in inclement conditions, including for example icy or snowy conditions, may additionally comprise a plurality of sipes in the tire tread. The addition of sipes in the tire tread may result in more surface edges in the tire tread for engagement with the icy or snowy roadway.

Increasing the length of a sipe, such as providing the sipe with a three-dimensional pattern, may increase the amount of cutting edges available to engage snowy, icy, and/or wet road surfaces.

Providing the sipe with a three-dimensional pattern in at least one of the lateral direction of the tire and the radial direction of the tire, may allow opposing walls of the sipe to at least partially engage one another in a high friction, or locking, manner to maintain a desired stiffness of the tire tread block or tire tread rib. Maintaining a specified level of stiffness in the tire tread may mitigate or eliminate irregular wear patterns. Maintaining a specified level of stiffness in the tire tread may improve stopping distance of the tire. Maintaining a specified level of stiffness in the tire tread may improve traction of the tire.

Traditional sipes comprise substantially radially-oriented, narrow slits extending from a tread surface into the tread. These traditional sipes typically include straight, parallel walls.

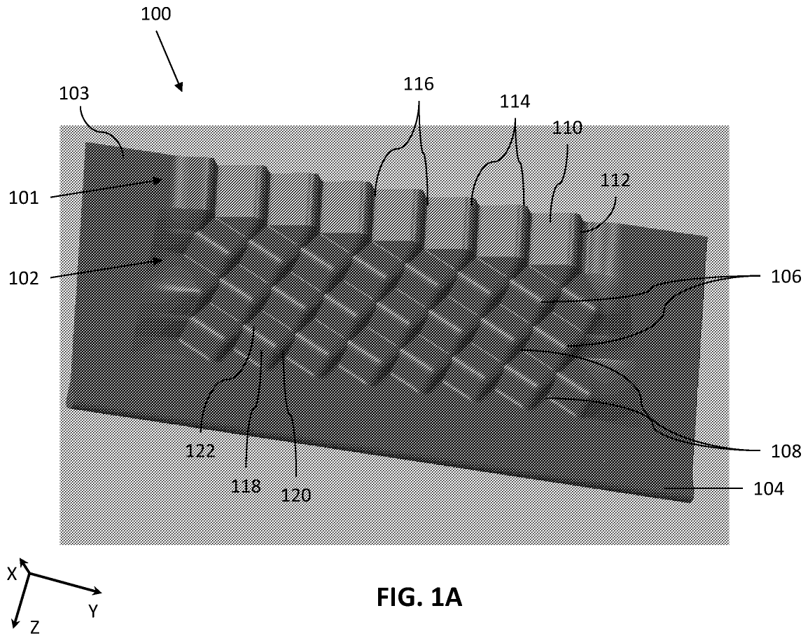

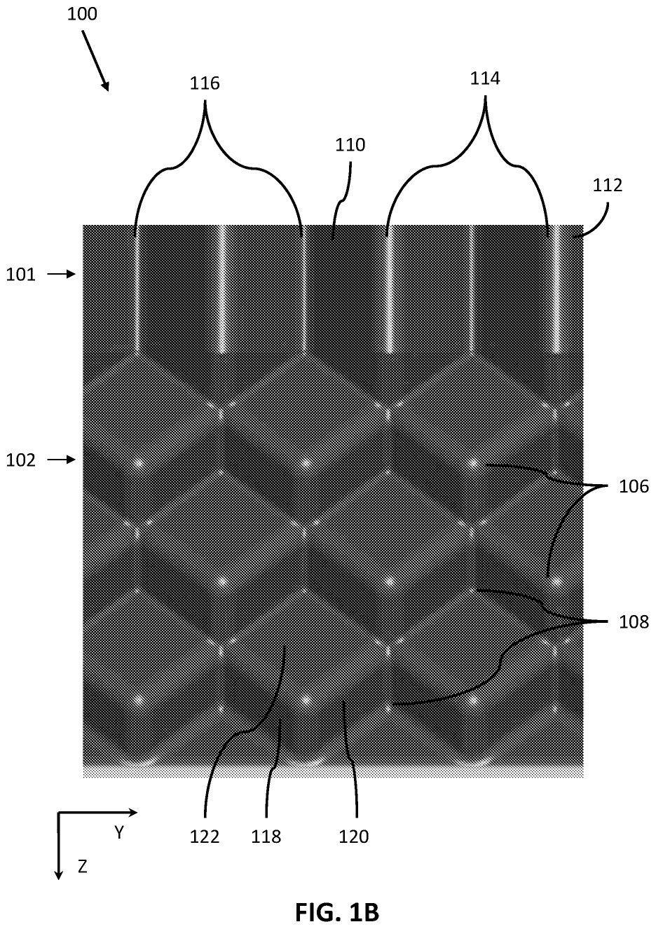

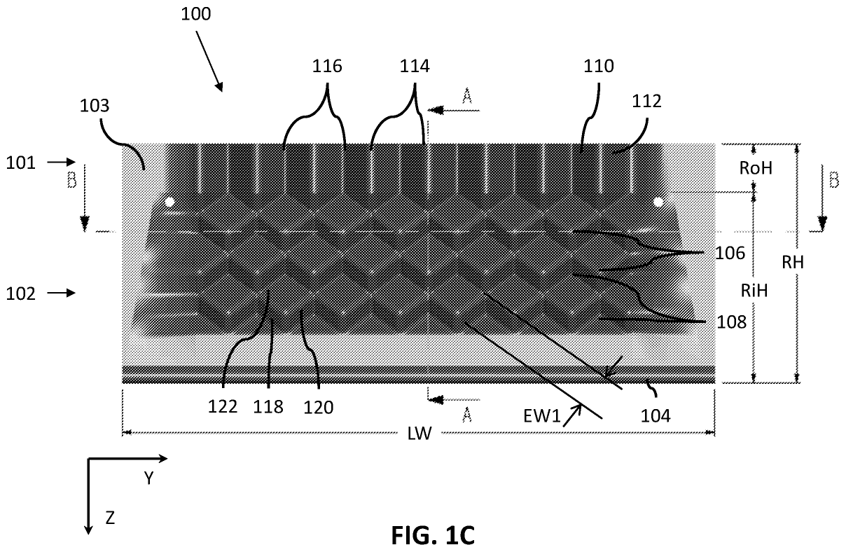

FIGS. 1A, 1B, and 1C illustrate an example sipe blade 100 for forming a three-dimensional tire sipe. Blade 100 may include a radially outer zig-zag portion 101, and a radially inner three-dimensional portion 102. Blade 100 may include a central plane 103, and a base 104.

Blade 100 may be used in conjunction with a mold to mold a three-dimensional sipe into a tire. The use of blade 100 results in the creation of a negative of blade 100 being formed in a sipe of a tire, creating the three-dimensional sipe.

Blade 100 may be formed using a thin sheet of material pressed into a desired shape, and generally having a material thickness that is consistent at least through radially outer zig-zag portion 101 and radially inner three-dimensional portion 102. Blade 100 may be formed using a thin sheet of material pressed into a desired shape, and generally having a material thickness that is not constant in radially inner three-dimensional portion 102. Base 104 may have a material thickness that is different when compared to that of radially outer zig-zag portion 101 and radially inner three-dimensional portion 102. In this manner, it is understood that a feature that is positive (i.e., extending out of blade 100 on a first side of blade 100) is negative (i.e., extending into blade 100 on a second side of blade 100). Blade 100 may be formed using any of a variety of manufacturing methods, including for example, machining, three-dimensional printing, casting, stamping, and the like, so as to produce the relationship described herein between positive elements and negative elements on exact opposite sides of blade 100. This arrangement is shared by each blade described herein.

Blade 100 may be formed from any of a variety of materials, including for example a metal (e.g., a steel or an alloy), a polymer, a ceramic, a composite, and the like. Blade 100 may be formed from a material capable of withstanding the heat and pressure associated with molding a tire.

It is understood that when molding a tire using a sipe blade, such as blade 100 (and all other blades described below), base 104 forms the base of a sipe in a tire, while radially outer zig-zag portion would form the ground-contacting radially outer portion of the sipe. Blade 100 may be affixed into a tire mold in such a manner to effect this molding orientation. As such, the term “radially outer zig-zag portion” reflects the fact that a three-dimensional sipe molded into a tire using blade 100 (and all other blades described below) would include the zig-zag feature molded by radially outer zig-zag portion 101 in a portion of the three-dimensional sipe that is oriented radially outward relative to the remainder of the three-dimensional sipe. Similarly, the term “radially inner three-dimensional portion” reflects the fact that a three-dimensional sipe molded into a tire using blade 100 (and all other blades described below) would include the three-dimensional feature molded by radially inner three-dimensional portion 102 in a portion of the three-dimensional sipe that is oriented radially inward relative to radially outer zig-zag portion 101.

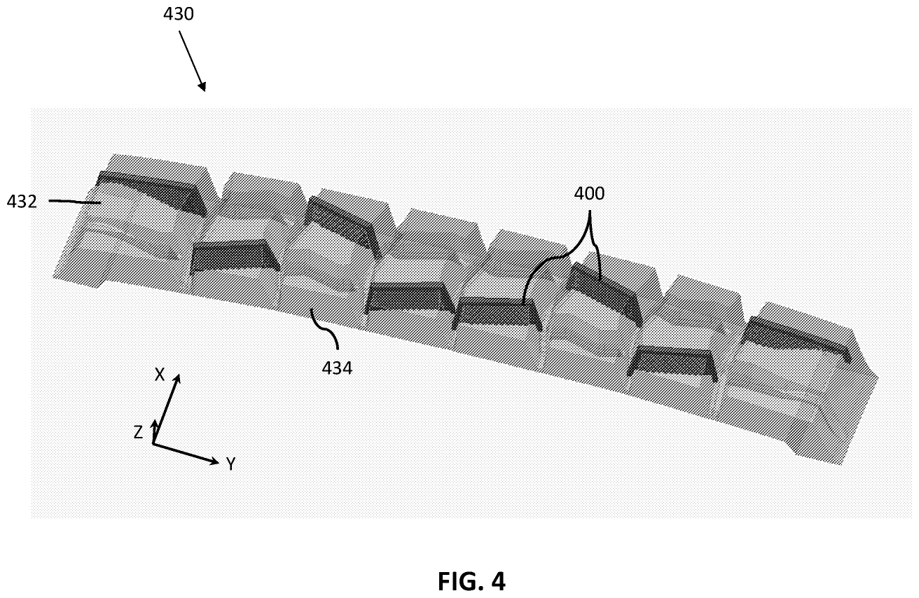

The X, Y, and Z axes illustrated in the figures are utilized for ease of description of the invention, and are not intended as limiting. In some instances, the X-axis may be generally tangential to the circumferential direction of a tire, the Y-axis may be generally parallel to the axial direction of a tire, and the Z-axis may be generally parallel to the radial direction of a tire. In some instances, the X-axis may be exactly tangential to the circumferential direction of a tire, the Y-axis may be exactly parallel to the axial direction of a tire, and the Z-axis may be exactly parallel to the radial direction of a tire. However, as illustrated in FIG. 4, sipes formed using blade 100 (and all blades described herein) are not necessarily aligned as described above, but rather, may be inclined relative to the axial, circumferential, and/or radial directions of the tire. In this sense, the X, Y, and Z axes are not limiting, but are utilized for convenience.

Blade 100 may include a plurality of positive elements 106 and a plurality of negative elements 108. Collectively, these features may form the three-dimensional feature described herein. That is, a pattern of alternating positive elements 106 and negative elements 108 may form the three-dimensional feature described as radially inner three-dimensional portion 102.

Radially inner three-dimensional portion 102 may have a height RiH. Blade 100 may have a height RH. Height RiH may be about 62% of blade radial height RH. Height RiH may be 62% of blade radial height RH. Height RiH may be about 77% of blade radial height RH. Height RiH may be 77% of blade radial height RH. Height RiH may be about 80% of blade radial height RH. Height RoH may be 80% of blade radial height RH. Height RiH may be between about 60% and about 80% of blade radial height RH. Height RiH may be between 60% and 80% of blade radial height RH. Height RiH may be between about 55% and about 85% of blade radial height RH. Height RiH may be between 55% and 85% of blade radial height RH. A sipe molded into a tire using blade 100 will have the same relationship in heights of RH and RiH.

As illustrated further below, positive elements 106 and negative elements 108 may result in corresponding positive elements and negative elements in a three-dimensional tire sipe molded using blade 100. These corresponding positive elements and negative elements may interlock with one another so as to create stiffness in a tire tread element having the three-dimensional sipe. The corresponding features may come together along the X-axis, to provide greater shear strength in the Y-Z plane between opposing faces of a sipe, as compared to a traditional, straight wall sipe.

Radially outer zig-zag portion 101 may be formed by a series of alternating angled surfaces 110 and 112, which form radially-extending peaks 114 and valleys 116. These peaks and valleys may form corresponding peaks and valleys in a tire sipe molded using blade 100. These corresponding peaks and valleys may interlock with one another so as to create stiffness in a tire tread element having the three-dimensional sipe.

Radially outer zig-zag portion 101 may have a height RoH. Height RoH may be about 20% of blade radial height RH. Height RoH may be 20% of blade radial height RH. Height RoH may be about 23% of blade radial height RH. Height RoH may be 23% of blade radial height RH. Height RoH may be about 37% of blade radial height RH. Height RoH may be 37% of blade radial height RH. Height RoH may be between about 20% and about 40% of blade radial height RH. Height RoH may be between 20% and 40% of blade radial height RH. Height RoH may be between about 15% and about 45% of blade radial height RH. Height RoH may be between 15% and 45% of blade radial height RH. A sipe molded into a tire using blade 100 will have the same relationship in heights of RH and RoH.

The interlocking aspect of the features described herein (in reference to each of the three-dimensional sipes herein) may result in a tire tread sipe that has the increased surface area desired when the sipe is “open” (e.g., while running down a roadway), but may result in increased stiffness when the sipe is “closed” (e.g., under breaking or when heavy tractive forces are applied, which may result in the tread element containing the sipe to be deformed).

Each of the three-dimensional features forming the plurality of positive elements 106 and a plurality of negative elements 108 may be made up of three planar surfaces 118, 120, and 122. For the ease of description, planar surfaces 118 and 120 may be referred to as side surface 118 and side surface 120, while planar surface 122 may be referred to as top surface 122. It is understood that these terms are not intended to be limiting, but rather, are used to simply clarify the relationship between these surfaces.

Each of planar surfaces 118, 120, and 122 may be angled relative to one another by about 90 degrees. Each of planar surfaces 118, 120, and 122 may be angled relative to one another by 90 degrees. Each of planar surfaces 118, 120, and 122 may be angled relative to one another by between about 85 degrees and about 95 degrees. Each of planar surfaces 118, 120, and 122 may be angled relative to one another by between 85 degrees and 95 degrees. Each of planar surfaces 118, 120, and 122 may be angled relative to one another by between about 80 degrees and about 100 degrees. Each of planar surfaces 118, 120, and 122 may be angled relative to one another by between 80 degrees and 100 degrees. Each of planar surfaces 118, 120, and 122 may be angled relative to one another by between about 75 degrees and about 105 degrees. Each of planar surfaces 118, 120, and 122 may be angled relative to one another by between 75 degrees and 105 degrees.

In one embodiment, the point at which each of planar surfaces 118, 120, and 122 meet may be a rounded, terminal portion. The terminal portion may have a radius.

Each of planar surfaces 118, 120, and 122 may have a quadrilateral shape. One or more of planar surfaces 118, 120, and 122 may be at least one of a square, a rectangle, a rhombus, and a parallelogram. In one embodiment, each of planar surfaces 118, 120, and 122 is a square. In another embodiment, top surface 122 may be square, while side surfaces 118, 120 are rectangular.

In one embodiment, top surface 122 may have a width EW1. Top surface 122 may be square, and thus may have a width EW1 about each of its four sides. Where side surfaces 118, 120 are rectangular, side surfaces 118, 120 may also have a width EW1 about two sides, with a height being greater than or less than EW1, which will be further described below.

Blade 100 may have a longitudinal width LW.

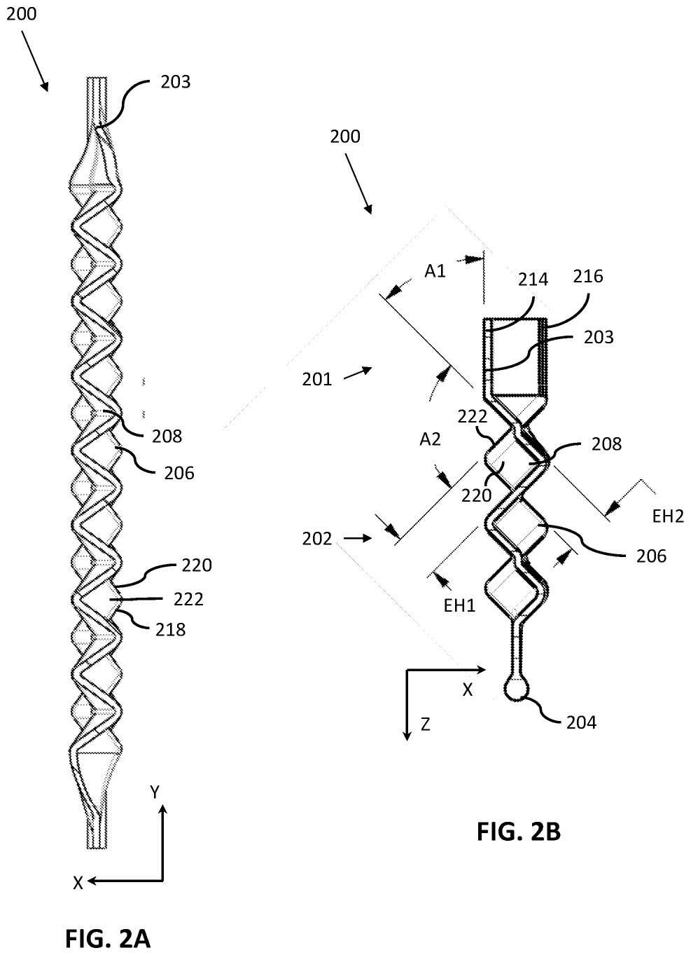

FIGS. 2A and 2B illustrate sectional views of an example sipe blade 200 for forming a three-dimensional tire sipe. FIG. 2A represents a sectional view taken about line B-B in FIG. 1C. FIG. 2B represents a sectional view taken about line A-A in FIG. 1C.

Sipe blade 200 may include a radially outer zig-zag portion 201, and a radially inner three-dimensional portion 202. Blade 200 may include a central plane 203, and a base 204.

Blade 200 may include a plurality of positive elements 206 and negative elements 208. The plurality of positive elements 206 and negative elements 208 may be made up planar surfaces 218, 220, and 222. Blade 200 may include a plurality of valleys 216 and peaks 214 oriented in the radially outer zig-zag portion 201.

In one embodiment, central plane 203 bisects the plurality of positive elements 206 and negative elements 208.

Each of the plurality of positive elements 206 and negative elements 208 may have a height EH1, EH2. Height EH1, EH2 may be equal to width EW1 described above with respect to FIG. 1C. Height EH1, EH2 may be less than width EW1 described above with respect to FIG. 1C. Height EH1, EH2 may be greater than width EW1 described above with respect to FIG. 1C. Height EH1, EH2 may about 71.5% of width EW1. Height EH1, EH2 may 71.5% of width EW1. Height EH1, EH2 may between about 70% and about 75% of width EW1. Height EH1, EH2 may between 70% and 75% of width EW1. Height EH1, EH2 may between about 65% and about 80% of width EW1. Height EH1, EH2 may between 65% and 80% of width EW1. Height EH1, EH2 may between about 60% and about 85% of width EW1. Height EH1, EH2 may between 60% and 85% of width EW1. A sipe molded into a tire using blade 200 will have the same relationship in heights EH1, EH2, and width EW1.

The line formed by the intersection of planar surfaces 218 and 220 may be oriented at an angle A1 relative to peak 214 (and central plane 203). Angle A1 may be about 45 degrees. Angle A1 may be 45 degrees.

The line formed by the intersection of planar surfaces 218 and 220 may be oriented at an angle A2 relative to planar surface 222 (forming the top surface). Angle A2 may be about 90 degrees. Angle A2 may be 90 degrees.

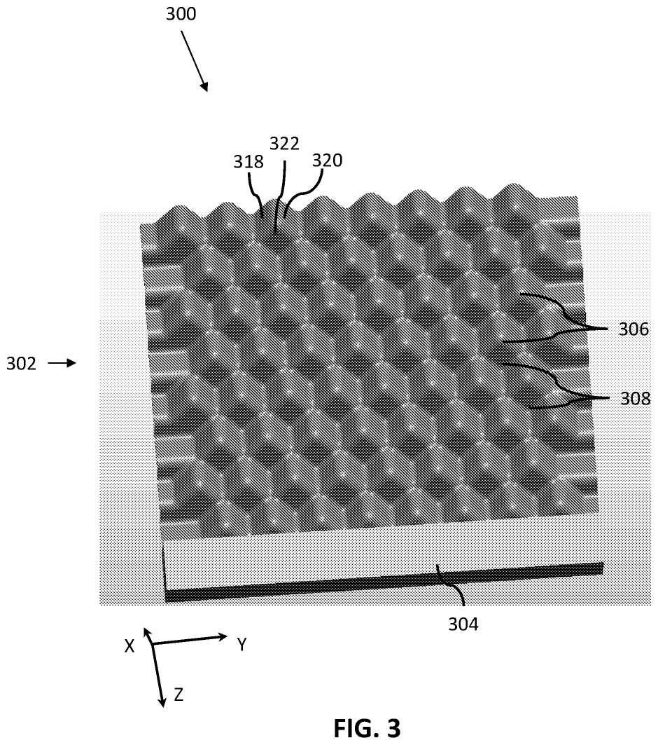

FIG. 3 illustrates a perspective view of an example sipe blade 300 for forming a three-dimensional tire sipe. Blade 300 may include a three-dimensional portion 302. Blade 300 may include a central plane (not shown), and a base 304.

Blade 300 may include a plurality of positive elements 306 and a plurality of negative elements 308. Collectively, these features may form the three-dimensional feature described herein. That is, a pattern of alternating positive elements 306 and negative elements 308 may form the three-dimensional feature described as radially inner three-dimensional portion 302.

Each of the three-dimensional features forming the plurality of positive elements 306 and a plurality of negative elements 308 may be made up of three planar surfaces 318, 320, and 322. For the ease of description, planar surfaces 318 and 320 may be referred to as side surface 318 and side surface 320, while planar surface 322 may be referred to as top surface 322. It is understood that these terms are not intended to be limiting, but rather, are used to simply clarify the relationship between these surfaces.

Each of planar surfaces 318, 320, and 322 may be angled relative to one another by about 90 degrees. Each of planar surfaces 318, 320, and 322 may be angled relative to one another by 90 degrees.

Each of planar surfaces 318, 320, and 322 may be square in shape, with all four sides being equal in length.

FIG. 4 illustrates a perspective view of a tire section 430 illustrating molding using a sipe blade 400 for forming a three-dimensional tire sipe.

Tire section 430 may include a tread portion 432. Tread portion 432 may include at least one tread element 434. Tread element 434 may be a block or a rib. Tread element 434 may include at least one sipe formed by blade 400. Blade 400 is structurally similar to blades 100, 200, and 300 discussed above. As illustrated, some sipes may be oriented substantially parallel to the axial direction of the tire, while others may be inclined relative to at least one of the axial, circumferential, and radial directions of the tire. As illustrated, the axial direction is parallel to the Y-axis, the circumferential direction is parallel to the X-axis, and the radial direction is parallel to the Z-axis.

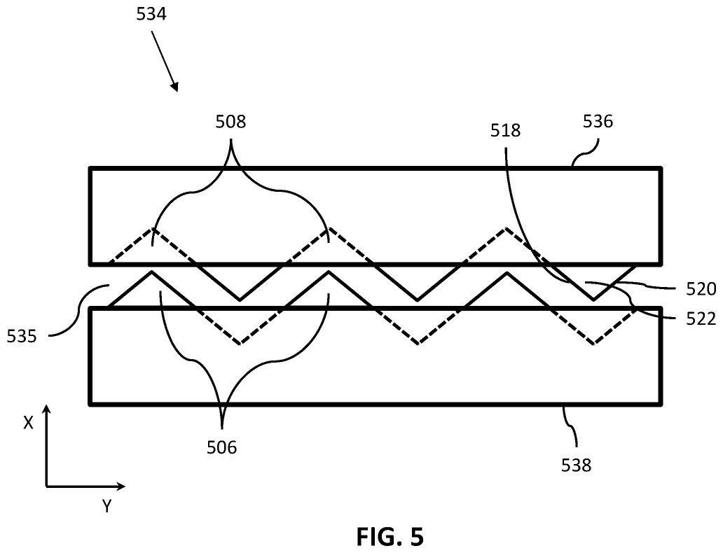

FIG. 5 illustrates a plan view of a tire tread element 534 illustrating engagement between a first and second element of a three-dimensional tire sipe. Tread element 534 may be at least partially bisected by a three-dimensional sipe 535, forming a first tread element portion 536 and a second tread element portion 538. Tread element portions 536, 538 may include a plurality of positive elements 506 and a plurality of negative elements 508.

Each of the three-dimensional features forming the plurality of positive elements 506 and a plurality of negative elements 508 may be made up of three planar surfaces 518, 520, and 522. For the ease of description, planar surfaces 518 and 520 may be referred to as side surface 518 and side surface 520, while planar surface 522 may be referred to as top surface 522. It is understood that these terms are not intended to be limiting, but rather, are used to simply clarify the relationship between these surfaces.

Each of planar surfaces 518, 520, and 522 may be angled relative to one another by about 90 degrees. Each of planar surfaces 518, 520, and 522 may be angled relative to one another by 90 degrees.

In practice, three-dimensional sipe 535 may be in contact with a running surface of a tire. When the tire is subjected to forces, tread element portions 536, 538 may extend toward one another, for example, along the X-axis, such that positive elements 506 may at least partially engage and interlock with negative elements 508, and vice versa. In this manner, three-dimensional sipe 535 may perform its function as a sipe (increasing surface area of tractive elements in a tire), while maintaining the rigidity of tread element 534. That is, the engagement of positive elements 506 with negative elements 508 may greater provide shear strength in tread element 534 in at least one of a radial direction, axial direction, and circumferential direction of the tire, as compared to a traditional, straight wall sipe.

The forces subjected to tread element portions 536, 538 that may cause interlocking thereof include forces applied to a tire when a vehicle using that tire at least one of: brakes, accelerates, and corners.

It is understood that a tire made using blades 100, 200, 300, and 400 would have sipes including the characteristics and features of the three-dimensional and two-dimensional elements of blades 100, 200, 300, and 400, but in a negative.

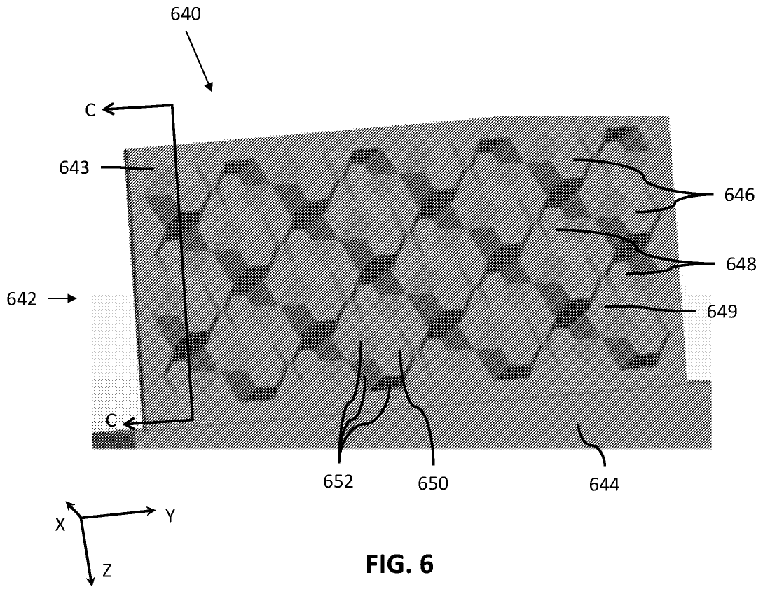

FIG. 6 illustrates a perspective view of an example sipe blade 600 for forming a three-dimensional tire sipe. Blade 640 may include a three-dimensional portion 642. Blade 640 may include a central plane 643, and a base 644.

Blade 640 may include a plurality of positive elements 646 and a plurality of negative elements 648. Collectively, these features may form the three-dimensional feature described herein. That is, a pattern of alternating positive elements 646 and negative elements 648 may form the three-dimensional feature described as radially inner three-dimensional portion 642. Each positive feature 646 and negative feature 648 may be separated by diagonally-adjacent positive feature 646 and negative elements 648 by a planar, diamond-shaped intermediate portion 649, which may be coplanar with central plane 643, and coplanar with the centerline of a sipe formed by blade 640. As described above, what appear as positive elements 646 at a specific point on one side of blade 640 appear as negative elements 648 on the exact opposite side of blade 640.

Each of the three-dimensional features forming the plurality of positive elements 646 and a plurality of negative elements 648 may be made up of seven planar surfaces 650 and 652. For the ease of description, planar surfaces 650 and 652 may be referred to as side surfaces 652 and terminal surface 650. It is understood that these terms are not intended to be limiting, but rather, are used to simply clarify the relationship between these surfaces.

Each of the three-dimensional features forming the plurality of positive elements 646 and a plurality of negative elements 648 may be made up of six side surfaces 652 capped by a terminal surface 650. Each side surface 652 may be oriented in the shape of a trapezoid, and may be oriented at an angle of about 120 degrees relative to adjacent side surfaces 652. Each side surface 652 may be oriented at an angle of 120 degrees relative to adjacent side surfaces 652. Terminal surface 650 may be hexagonal in shape.

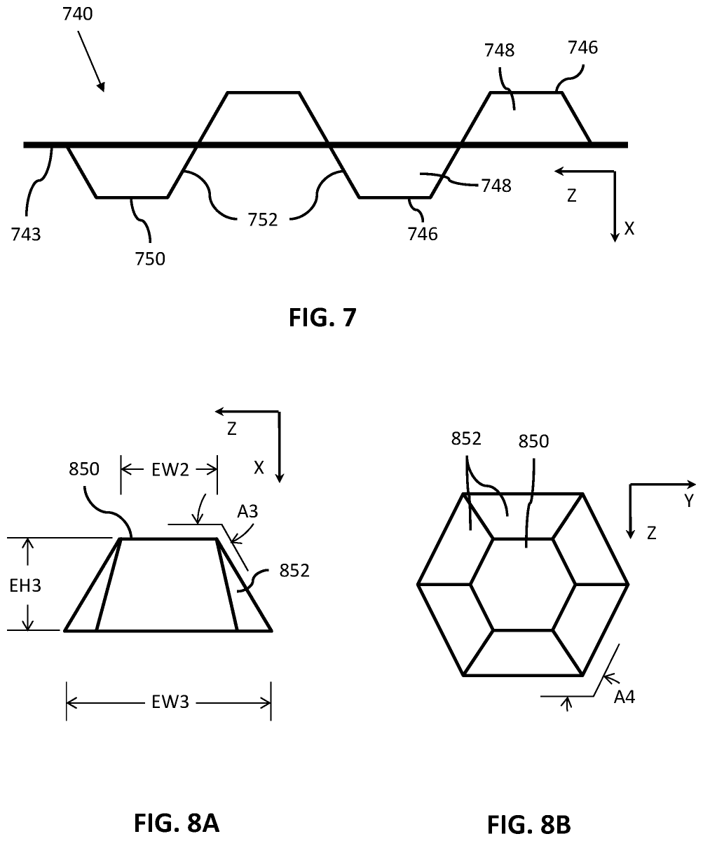

FIG. 7 illustrates a sectional view of an example sipe blade 740 for forming a three-dimensional tire sipe. FIG. 7 represents a sectional view taken about line C-C in FIG. 6. Blade 740 may include a central plane 743. Blade 740 may include a plurality of positive elements 746 and a plurality of negative elements 748. Collectively, these features may form the three-dimensional feature described herein. Each element forming positive elements 746 and negative elements 748 may include a plurality of planar, side surfaces 752, capped by a planar, terminal surface 750. Terminal surface 750 may be parallel to central plane 743, and likewise parallel to a centerline of a sipe formed using blade 740.

As illustrated, the same element forming positive feature 746 on one side of blade 740 forms negative feature 748 when viewed from the opposite side of blade 740.

FIGS. 8A and 8B illustrate elevation and plan views, respectively, of a three-dimensional element for forming a three-dimensional tire sipe. The element may include a planar, terminal surface 850, and a plurality of planar, side surfaces 852. Each element may have an element width EW2 that is the width of terminal surface 850, and an element width EW3 that is the width of the base of the element. EW2 may be about 50% of EW3. EW2 may be 50% of EW3. EW2 may be between about 40% and about 60% of EW3. EW2 may be between 40% and 60% of EW3. EW2 may be between about 30% and about 70% of EW3. EW2 may be between 30% and 70% of EW3. A sipe molded into a tire using a sipe blade having these elements will have the same relationship in element widths EW2 and EW3.

The element may include an element height EH3, which is about equal to EW2. EH3 may be equal to EW2. EH3 may be less than EW2. EH3 may be greater than EW2.

Each side surface 852 may be oriented at an angle A3 relative to terminal surface 850. Angle A3 may be about 38 degrees. Angle A3 may be 38 degrees. Angle A3 may be between about 35 degrees and 45 degrees. Angle A3 may be between 35 degrees and 45 degrees. Angle A3 may be between about 30 degrees and about 50 degrees. Angle A3 may be between 30 degrees and 50 degrees. Angle A3 may be greater than 38 degrees. Angle A3 may be less than 38 degrees.

Each side surface 852 may be oriented at an angle A4 relative to adjacent side surfaces. Angle A4 may be about 120 degrees. Angle A4 may be 120 degrees. Angle A4 may be greater than 120 degrees. Angle A4 may be less than 120 degrees.

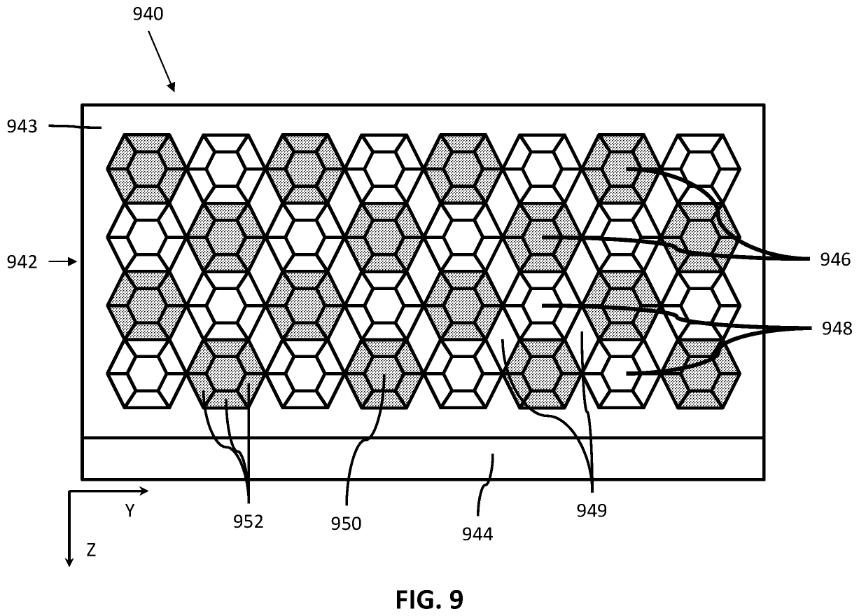

FIG. 9 illustrates an elevation view of an example sipe blade 900 for forming a three-dimensional tire sipe. Blade 940 may include a three-dimensional portion 942. Blade 940 may include a central plane 943, and a base 944.

Blade 940 may include a plurality of positive elements 946 and a plurality of negative elements 948. Collectively, these features may form the three-dimensional feature described herein. That is, a pattern of alternating positive elements 946 and negative elements 948 may form the three-dimensional feature described as radially inner three-dimensional portion 942. Each positive feature 946 and negative feature 948 may be separated by diagonally-adjacent positive feature 946 and negative elements 948 by a planar, diamond-shaped intermediate portion 949, which may be coplanar with central plane 943, and coplanar with the centerline of a sipe formed by blade 940. As described above, what appear as positive elements 946 at a specific point on one side of blade 940 appear as negative elements 948 on the exact opposite side of blade 940.

Each of the three-dimensional features forming the plurality of positive elements 946 and a plurality of negative elements 948 may be made up of seven planar surfaces 950 and 952. For the ease of description, planar surfaces 950 and 952 may be referred to as side surfaces 952 and terminal surface 950. It is understood that these terms are not intended to be limiting, but rather, are used to simply clarify the relationship between these surfaces.

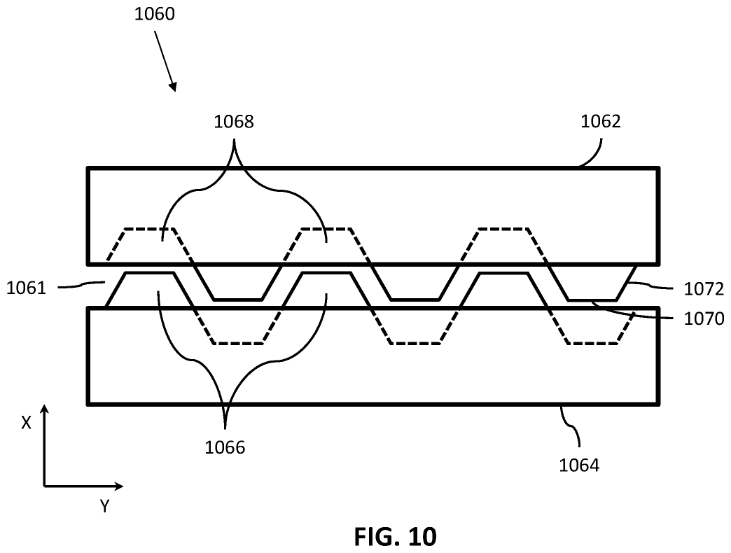

FIG. 10 illustrates a plan view of a tire tread element 1060 illustrating engagement between a first and second element of a three-dimensional tire sipe. Tread element 1060 may be at least partially bisected by a three-dimensional sipe 1061, forming a first tread element portion 1062 and a second tread element portion 1064. Tread element portions 1062, 1064 may include a plurality of positive elements 1066 and a plurality of negative elements 1068.

Each of the three-dimensional features forming the plurality of positive elements 1066 and a plurality of negative elements 1068 may be made up of seven planar surfaces, six being side surfaces 1072, and one being terminal surface 1070. It is understood that these terms are not intended to be limiting, but rather, are used to simply clarify the relationship between these surfaces.

In practice, three-dimensional sipe 1061 may be in contact with a running surface of a tire. When the tire is subjected to forces, tread element portions 1062, 1064 may extend toward one another, for example, along the X-axis, such that positive elements 1066 may at least partially engage and interlock with negative elements 1068, and vice versa. In this manner, three-dimensional sipe 1061 may perform its function as a sipe (increasing surface area of tractive elements in a tire), while maintaining the rigidity of tread element 1060. That is, the engagement of positive elements 1066 with negative elements 1068 may provide greater shear strength in tread element 1060 in at least one of a radial direction, axial direction, and circumferential direction of the tire, as compared to a traditional, straight wall sipe.

The forces subjected to tread element portions 1062, 1064 that may cause interlocking thereof include forces applied to a tire when a vehicle using that tire at least one of: brakes, accelerates, and corners.

It is understood that a tire made using blades 640, 740, and 940 would have sipes including the characteristics and features of the three-dimensional and two-dimensional elements of blades 640, 740, and 940, but in a negative.

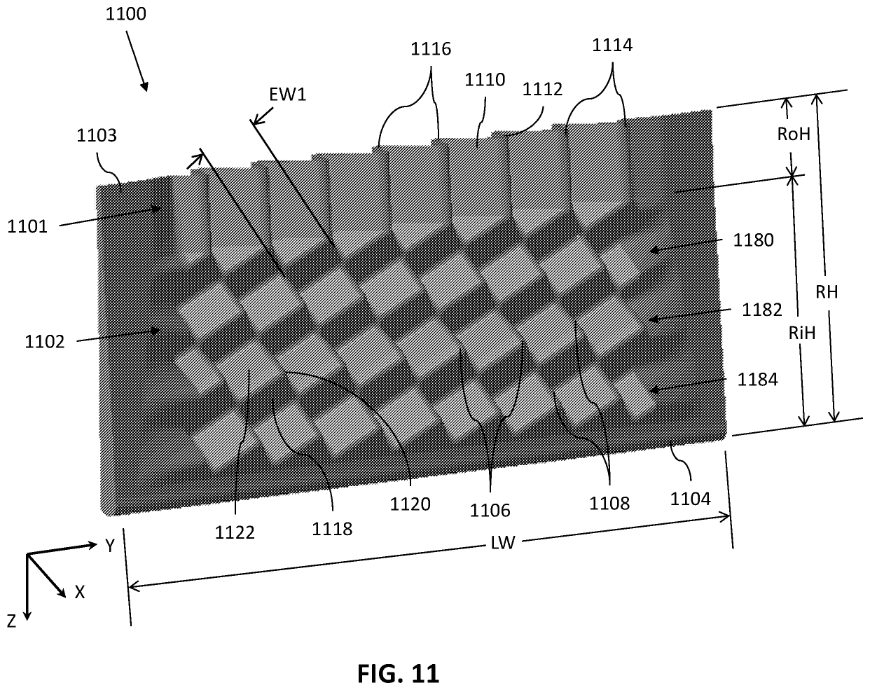

FIG. 11 illustrates a perspective view of an example sipe blade 1100 for forming a three-dimensional tire sipe. Blade 1100 may include a radially outer zig-zag portion 1101, and a radially inner three-dimensional portion 1102. Blade 1100 may include a central plane 1103, and a base 1104.

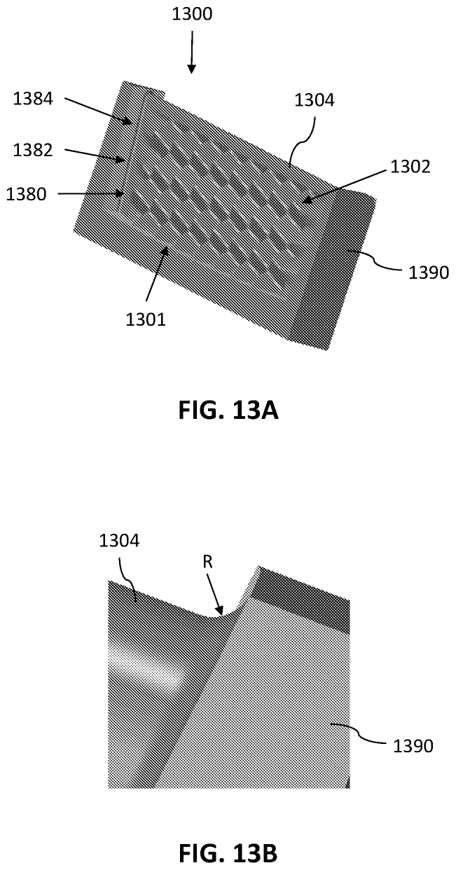

Blade 1100 may be used in conjunction with a mold (1390 in FIGS. 13A and 13B) to mold a three-dimensional sipe into a tire. The use of blade 1100 results in the creation of a negative of blade 1100 being formed in a sipe of a tire, creating the three-dimensional sipe.

Blade 1100 may be formed using a thin sheet of material pressed into a desired shape, and having a material thickness that is not constant at least through radially outer zig-zag portion 1101. Base 1104 may have a material thickness that is different when compared to that of radially outer zig-zag portion 1101 and radially inner three-dimensional portion 1102. In this manner, it is understood that a feature that is positive (i.e., extending out of blade 1100 on a first side of blade 1100) is negative (i.e., extending into blade 1100 on a second side of blade 1100). Blade 1100 may be formed using any of a variety of manufacturing methods, including for example, machining, three-dimensional printing, casting, stamping, and the like, so as to produce the relationship described herein between positive elements and negative elements on exact opposite sides of blade 1100. This arrangement is shared by each blade described herein.

Blade 1100 may be formed from any of a variety of materials, including for example a metal (e.g., a steel or an alloy), a polymer, a ceramic, a composite, and the like. Blade 1100 may be formed from a material capable of withstanding the heat and pressure associated with molding a tire.

It is understood that when molding a tire using a sipe blade, such as blade 1100 (and all other blades described below), base 1104 would form the base of a sipe, whereas radially outer zig-zag portion 1101 would form the ground-contacting radially outer portion of the sipe. Blade 1100 may be affixed into a tire mold in such a manner to effect this molding orientation. As such, the term “radially outer zig-zag portion” reflects the fact that a three-dimensional sipe molded into a tire using blade 1100 (and all other blades described below) would include the zig-zag feature molded by radially outer zig-zag portion 1101 in a portion of the three-dimensional sipe that is oriented radially outward relative to the remainder of the three-dimensional sipe. Similarly, the term “radially inner three-dimensional portion” reflects the fact that a three-dimensional sipe molded into a tire using blade 1100 (and all other blades described below) would include the three-dimensional feature molded by radially inner three-dimensional portion 1102 in a portion of the three-dimensional sipe that is oriented radially inward relative to radially outer zig-zag portion 1101.

The X, Y, and Z axes illustrated in the figures are utilized for ease of description of the invention, and are not intended as limiting. In some instances, the X-axis may be generally tangential to the circumferential direction of a tire, the Y-axis may be generally parallel to the axial direction of a tire, and the Z-axis may be generally parallel to the radial direction of a tire. In some instances, the X-axis may be exactly tangential to the circumferential direction of a tire, the Y-axis may be exactly parallel to the axial direction of a tire, and the Z-axis may be exactly parallel to the radial direction of a tire. However, as illustrated in FIG. 4, sipes formed using blade 1100 (and all blades described herein) are not necessarily aligned as described above, but rather, may be inclined relative to the axial, circumferential, and/or radial directions of the tire. In this sense, the X, Y, and Z axes are not limiting, but are utilized for convenience.

Blade 1100 may include a plurality of positive elements 1106 and a plurality of negative elements 1108. Collectively, these features may form the three-dimensional feature 1102 described herein. That is, a pattern of alternating positive elements 1106 and negative elements 1108 may form the three-dimensional feature described as radially inner three-dimensional portion 1102.

Radially inner three-dimensional portion 1102 may have a height RiH. Blade 1100 may have a height RH. Height RiH may be about 62% of blade radial height RH. Height RiH may be 62% of blade radial height RH. Height RiH may be about 77% of blade radial height RH. Height RiH may be 77% of blade radial height RH. Height RiH may be about 80% of blade radial height RH. Height RiH may be 80% of blade radial height RH. Height RiH may be between about 60% and about 80% of blade radial height RH. Height RiH may be between 60% and 80% of blade radial height RH. Height RiH may be between about 55% and about 85% of blade radial height RH. Height RiH may be between 55% and 85% of blade radial height RH. A sipe molded into a tire using blade 1100 will have the same relationship in heights of RH and RiH.

As illustrated further below, positive elements 1106 and negative elements 1108 may result in corresponding positive elements and negative elements in a three-dimensional tire sipe molded using blade 1100. These corresponding positive elements and negative elements may interlock with one another so as to create stiffness in a tire tread element having the three-dimensional sipe. The corresponding features may come together along the X-axis, to provide greater shear strength in the Y-Z plane between opposing faces of a sipe, as compared to a traditional, straight wall sipe.

Radially outer zig-zag portion 1101 may be formed by a series of alternating angled surfaces 1110 and 1112, which form radially-extending peaks 1114 and valleys 1116. These peaks and valleys may form corresponding peaks and valleys in a tire sipe molded using blade 1100. These corresponding peaks and valleys may interlock with one another so as to create stiffness in a tire tread element having the three-dimensional sipe.

Radially outer zig-zag portion 1101 may have a height RoH. Height RoH may be about 20% of blade radial height RH. Height RoH may be 20% of blade radial height RH. Height RoH may be about 23% of blade radial height RH. Height RoH may be 23% of blade radial height RH. Height RoH may be about 37% of blade radial height RH. Height RoH may be 37% of blade radial height RH. Height RoH may be between about 20% and about 40% of blade radial height RH. Height RoH may be between 20% and 40% of blade radial height RH. Height RoH may be between about 15% and about 45% of blade radial height RH. Height RoH may be between 15% and 45% of blade radial height RH. A sipe molded into a tire using blade 1100 will have the same relationship in heights of RH and RoH.

The interlocking aspect of the features described herein (in reference to each of the three-dimensional sipes herein) may result in a tire tread sipe that has the increased surface area desired when the sipe is “open” (e.g., while running down a roadway), but may result in increased stiffness when the sipe is “closed” (e.g., under breaking or when heavy tractive forces are applied, which may result in the tread element containing the sipe to be deformed).

Each of the three-dimensional features forming the plurality of positive elements 1106 and a plurality of negative elements 1108 may be made up of three planar surfaces 1118, 1120, and 1122. For the ease of description, planar surfaces 1118 and 1120 may be referred to as side surface 1118 and side surface 1120, while planar surface 1122 may be referred to as top surface 1122. It is understood that these terms are not intended to be limiting, but rather, are used to simply clarify the relationship between these surfaces.

Each of planar surfaces 1118, 1120, and 1122 may be angled relative to one another by about 90 degrees. Each of planar surfaces 1118, 1120, and 1122 may be angled relative to one another by 90 degrees. Each of planar surfaces 1118, 1120, and 1122 may be angled relative to one another by between about 85 degrees and about 95 degrees. Each of planar surfaces 1118, 1120, and 1122 may be angled relative to one another by between 85 degrees and 95 degrees. Each of planar surfaces 1118, 1120, and 1122 may be angled relative to one another by between about 80 degrees and about 100 degrees. Each of planar surfaces 1118, 1120, and 1122 may be angled relative to one another by between 80 degrees and 100 degrees. Each of planar surfaces 1118, 1120, and 1122 may be angled relative to one another by between about 75 degrees and about 105 degrees. Each of planar surfaces 1118, 1120, and 1122 may be angled relative to one another by between 75 degrees and 105 degrees.

In one embodiment, the point at which each of planar surfaces 1118, 1120, and 1122 meet may be a rounded, terminal portion. The terminal portion may have a radius.

Each of planar surfaces 1118, 1120, and 1122 may have a quadrilateral shape. One or more of planar surfaces 1118, 1120, and 1122 may be at least one of a square, a rectangle, a rhombus, and a parallelogram. In one embodiment, each of planar surfaces 1118, 1120, and 1122 is a square. In another embodiment, top surface 1122 may be square, while side surfaces 1118, 1120 are rectangular.

In one embodiment, top surface 1122 may have a width EW1. Top surface 1122 may be square, and thus may have a width EW1 about each of its four sides. Where side surfaces 1118, 1120 are rectangular, side surfaces 1118, 1120 may also have a width EW1 about two sides, with a height being greater than or less than EW1, which will be further described below.

Blade 1100 may have a longitudinal width LW.

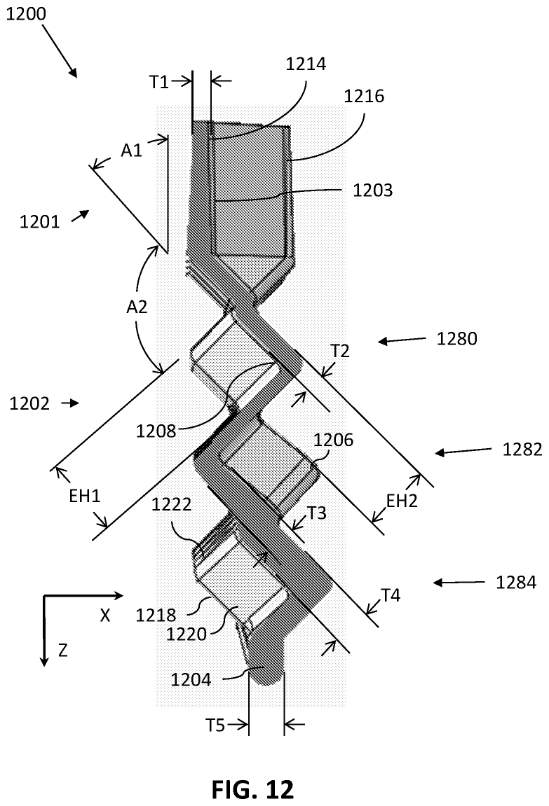

Blade 1100 may include a plurality of rows of positive elements 1106 and negative elements 1108. It is understood that any positive feature on a first side of blade 1100 forms a negative feature on the opposite side of blade 1100. For instance, blade 1100 may have three rows of positive elements 1106, including a first row 1180, a second row 1182, and a third row 1184, in order from a radially outer position to a radially inner position. At least two of rows 1180, 1182, and 1184 may have different material thicknesses relative to one another (illustrated in FIG. 12 as T2, T3, and T4). In one embodiment, each of rows 1180, 1182, and 1184 may have different thicknesses. For example, first row 1180 may have a thickness of about 0.5 mm, second row 1182 may have at thickness of about 0.5 mm, and third row 1184 may have a thickness of about 1.0 mm. In another example, first row 1180 may have a thickness of about 0.3 mm, second row 1182 may have at thickness of about 0.5 mm, and third row 1184 may have a thickness of about 1.0 mm. The thicknesses of each row may describe the average thickness of that row, as adjacent rows having different thicknesses may include a transition area from the thickness of one row to the thickness of the next. That is, a 0.5 mm row adjacent to a 1.0 mm row may include transition portions between those thicknesses, rather than an abrupt “step” between the two rows. The thickness of first row 1180 is the same as thickness T2 in FIG. 12. The thickness of second row 1182 is the same as thickness T3 in FIG. 12. The thickness of third row 1184 is the same as thickness T4 in FIG. 12.

In one embodiment, the radially outer rows have a lesser material thickness than radially inner rows. Rows may be defined as a series of features that are aligned in the longitudinal direction of the sipe (along the Y-axis in FIG. 11).

First row 1180 may have a thickness of between about 50% and 100% of second row 1182. First row 1180 may have a thickness of about 60% of second row 1182. First row 1180 may have a thickness of about 100% of second row 1182. First row 1180 may have a thickness of between about 30% and 50% of third row 1184. First row 1180 may have a thickness of about 30% of third row 1184. First row 1180 may have a thickness of about 50% of third row 1184.

Second row 1182 may have a thickness between about 40% and 100% of third row 1184. Second row 1182 may have a thickness between about 50% and 100% of third row 1184. Second row 1182 may have a thickness of about 50% of third row 1184.

Where blade 1100 includes additional rows, any row of blade 1100 may have a thickness between about 40% and 100%, or a thickness of about 50%, 60%, or 100% of adjacent rows.

Base 1104 may have a material thickness of about 1.0 mm. Base 1104 may have a thickness equal to third row 1184. Base 1104 may have a thickness greater than third row 1184.

One advantage of rows of varying thicknesses, with a general increase in thickness from a radially outer portion to a radially inner portion, may be a strengthening of blade 1100 to prevent breaking of blade 1100 during molding. Unexpectedly, base 1104 being as thick, or thicker, than any other portion of blade 1100 may cause base 1104 to act as a beam, providing greater structural integrity to blade 1100 when compared to prior art blade designs.

Another advantage of rows of varying thicknesses may be a widening of a sipe formed by blade 1100 as that sipe wears in a tire. That is, a sipe formed by blade 1100 will have a sipe width approximately equal to (with perhaps some degree of difference due to the molding process) the thickness of sipe blade 1100. Thus, a sipe formed by sipe blade 1100, which thickens as it extends radially inwardly, will likewise have a sipe width increasing as the sipe extends radially inwardly. Such an increase in width may result in mitigation or reduction of the degradation of various properties of the tire as it wears, including for example, traction, drainage, wear rate, handling, stopping, stiffness, and the like.

FIG. 12 illustrates a sectional view of an example sipe blade 1200 for forming a three-dimensional tire sipe.

Sipe blade 1200 may include a radially outer zig-zag portion 1201, and a radially inner three-dimensional portion 1202. Blade 1200 may include a central plane 1203, and a base 1204.

Blade 1200 may include a plurality of positive elements 1206 and negative elements 1208. The plurality of positive elements 1206 and negative elements 1208 may be made up planar surfaces 1218, 1220, and 1222. Blade 1200 may include a plurality of valleys 1216 and peaks 1214 oriented in the radially outer zig-zag portion 1201.

In one embodiment, central plane 1203 bisects the plurality of positive elements 1206 and negative elements 1208.

Each of the plurality of positive elements 1206 and negative elements 1208 may have a height EH1, EH2. Height EH1, EH2 may be equal to width EW1 described above with respect to FIG. 11. Height EH1, EH2 may be less than width EW1 described above with respect to FIG. 11. Height EH1, EH2 may be greater than width EW1 described above with respect to FIG. 11. Height EH1, EH2 may about 71.5% of width EW1. Height EH1, EH2 may 71.5% of width EW1. Height EH1, EH2 may between about 70% and about 75% of width EW1. Height EH1, EH2 may between 70% and 75% of width EW1. Height EH1, EH2 may between about 65% and about 80% of width EW1. Height EH1, EH2 may between 65% and 80% of width EW1. Height EH1, EH2 may between about 60% and about 85% of width EW1. Height EH1, EH2 may between 60% and 85% of width EW1. A sipe molded into a tire using blade 1200 will have the same relationship in heights EH1, EH2, and width EW1.

The line formed by the intersection of planar surfaces 1218 and 1220 may be oriented at an angle A1 relative to peak 1214 (and central plane 1203). Angle A1 may be about 45 degrees. Angle A1 may be 45 degrees.

The line formed by the intersection of planar surfaces 1218 and 1220 may be oriented at an angle A2 relative to planar surface 1222 (forming the top surface). Angle A2 may be about 90 degrees. Angle A2 may be 90 degrees.

Blade 1200 may have a plurality of rows of positive elements 1206 and negative elements 1208. For example, blade 1200 may include a first row 1280, a second row 1282, and a third row 1284. At least two of the rows may have different average material thicknesses relative to one another. First row 1280 may have a thickness T2, second row 1282 may have a thickness T3, and third row 1284 may have a thickness T4. The values of thicknesses T2, T3, and T4 are the same as those described above with respect to FIG. 11.

Blade 1200 may include alternating angled elements making up radially outer zig-zag portion 1201. The thickness T1 of the alternating angled elements may be the same as the thickness T2 of first row 1280. Alternatively, thickness T1 may have less than thickness T2.

Base 1204 may have a thickness T5 that is the same as thickness T4 of third row 1284. Alternatively, thickness T5 may be greater than thickness T4.

FIGS. 13A and 13B illustrate an example sipe blade 1300 arranged in a mold 1390 for forming a three-dimensional tire sipe. Blade 1300 may include a radially outer zig-zag portion 1301, and a radially inner three-dimensional portion 1302. Blade 1300 may include a base 1304.

Blade 1300 may include a plurality of rows of positive and negative elements forming radially inner three-dimensional portion 1302, including a first row 1380, a second row 1382, and a third row 1384.

Blade 1300 may be inserted into a mold 1390. Note that mold 1390 represents a portion of a mold simply to illustrate how blade 1300 would be inserted therein, and that base 1304 is not supported by mold 1390 along its length. Mold 1390 may contact and support three of the four sides of blade 1300, while base 1304 is unsupported along its length. Thus, base 1304 having a greater material thickness and acting as a beam may provide structural integrity and greater strength to this unsupported edge of blade 1300.

As illustrated in FIG. 13B, a radius R may be formed where base 1304 meets mold 1390 to reduce an stress concentration found at that point. Radius R forms a fillet.

It is understood that a tire made using blades 100, 200, 300, 400, 1100, 1200, and 1300 would have sipes including the characteristics and features of the three-dimensional and two-dimensional elements of blades 100, 200, 300, 400, 1100, 1200, and 1300, but in a negative.

Additionally, tires utilizing any of the three-dimensional sipes disclosed herein may yield better performance than a tire utilizing traditional two-dimensional (straight wall) sipes in the following common tire tests: cornering coefficient, snow braking, snow acceleration, snow lateral traction, tire wear, wet roadway lap time, and dry peak friction coefficient.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See Bryan A. Garner, A Dictionary of Modern Legal Usage 624 (2d. Ed. 1995). Also, to the extent that the terms “in” or “into” are used in the specification or the claims, it is intended to additionally mean “on” or “onto.” To the extent that the term “substantially” is used in the specification or the claims, it is intended to take into consideration the degree of precision available or prudent in manufacturing. To the extent that the term “selectively” is used in the specification or the claims, it is intended to refer to a condition of a component wherein a user of the apparatus may activate or deactivate the feature or function of the component as is necessary or desired in use of the apparatus. To the extent that the term “operatively connected” is used in the specification or the claims, it is intended to mean that the identified components are connected in a way to perform a designated function. As used in the specification and the claims, the singular forms “a,” “an,” and “the” include the plural. Finally, where the term “about” is used in conjunction with a number, it is intended to include ±10% of the number. In other words, “about 10” may mean from 9 to 11. Cartesian coordinates referenced herein are intended to comply with the SAE tire coordinate system.

As stated above, while the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art, having the benefit of the present application. Therefore, the application, in its broader aspects, is not limited to the specific details, illustrative examples shown, or any apparatus referred to. Departures may be made from such details, examples, and apparatuses without departing from the spirit or scope of the general inventive concept.

1. A tire having a sipe, comprising:
opposing tread element portions separated by the sipe, each opposing tread element portion including a plurality of positive elements and a plurality of negative elements,
wherein the plurality of positive elements and the plurality of negative elements include three substantially quadrilateral-shaped planar surfaces, each planar surface being oriented relative to another planar surface by an angle of 90 degrees, and
wherein the three planar surfaces meet at a rounded terminal portion.

2. The tire of claim 1, wherein the sipe includes a radially inner three-dimensional portion.

3. The tire of claim 1, wherein the sipe includes a radially inner three-dimensional portion and a radially outer zig-zag portion.

4. The tire of claim 3, wherein the radially outer zig-zag portion includes radially-extended peaks and valleys.

5. The tire of claim 2, wherein the radially inner three-dimensional portion includes a first row of elements, a second row of elements, and a third row of elements, and wherein at least two of the first row, the second row, and the third row have different material thicknesses relative to one another.

6. The tire of claim 5, wherein:
the first row has a material thickness between about 50% and 100% of the second row, and
the second row has a material thickness between about 50% and 100% of the third row.

7. The tire of claim 6, wherein the sipe include a base, and wherein the base has a material thickness equal to the material thickness of the third row.

8. A tire having a sipe, comprising:
opposing tread element portions separated by the sipe, each opposing tread element portion including a plurality of positive elements and a plurality of negative elements,
wherein the plurality of positive elements and the plurality of negative elements include six planar side surfaces having a trapezoidal shape, each planar side surface being oriented relative to an adjacent planar side surface by an angle of 120 degrees, and
wherein the six planar side surfaces are each connected to a planar terminal surface having a hexagonal shape, wherein the planar terminal portion is parallel to a sipe centerline.

9. The tire of claim 8, wherein each of the positive elements and the negative elements are separated by a planar, diamond-shaped intermediate portion that is coplanar with the sipe centerline.

10. The tire of claim 8, wherein each planar side surface is oriented at an angle relative to the planar terminal surface, wherein the angle is between 30 degrees and 50 degrees.

11. The tire of claim 8, wherein each of the positive elements and the negative elements have a height measured form the sipe centerline, wherein the planar terminal surface has a width, and wherein the element height is equal to the terminal surface width.

12. A sipe blade for forming a sipe in a tire, comprising:
a central plane, and
a plurality of positive elements and a plurality of negative elements,
wherein the plurality of positive elements and the plurality of negative elements include three substantially quadrilateral-shaped planar surfaces, each planar surface being oriented relative to another planar surface by an angle of 90 degrees, and
wherein the three planar surfaces meet at a rounded terminal portion.

13. The sipe blade of claim 12, wherein the three planar surfaces include two side surfaces and a top surface, wherein the side surfaces and the top surface are each square in shape.

14. The sipe blade of claim 12, wherein the sipe blade includes a radially inner three-dimensional portion.

15. The sipe blade of claim 12, wherein the sipe blade includes a radially inner three-dimensional portion and a radially outer zig-zag portion.

16. The sipe blade of claim 15, wherein the radially outer zig-zag portion includes radially-extended peaks and valleys.

17. The sipe blade of claim 12, wherein the positive elements of a first side of the sipe blade appear as negative elements on an exact opposite side of the sipe blade.

18. The sipe blade of claim 14, wherein the radially inner three-dimensional portion includes a first row of elements, a second row of elements, and a third row of elements, and wherein at least two of the first row, the second row, and the third row have different material thicknesses relative to one another.

19. The sipe blade of claim 14, wherein:
the first row has a material thickness between about 50% and 100% of the second row, and
the second row has a material thickness between about 50% and 100% of the third row.

20. The sipe blade of claim 19, wherein the sipe include a base, and wherein the base has a material thickness equal to the material thickness of the third row.
